(19) United States
(12) Patent Application Publication
(10) Pub. No.: US 2011/0104467 A1
(43) Pub. Date: May 5, 2011

(54) UV CURED INTERMEDIATE TRANSFER MEMBERS

(75) Inventors: Jin Wu, Pittsford, NY (US); Yuhua Tong, Webster, NY (US); Dante M. Pietrantoni, Rochester, NY (US); Jonathan H. Herko, Walworth, NY (US)

(73) Assignee: XEROX CORPORATION, Norwalk, CT (US)

(21) Appl. No.: 12/608,401

(22) Filed: Oct. 29, 2009

(51) Int. Cl. B32B 27/38; H01B 1/12; B32B 27/00; B32B 9/04; B32B 27/32; B32B 5/00

(52) U.S. Cl. 428/220; 252/501.1; 428/422; 428/421; 428/447; 428/523; 428/413; 428/411.1; 428/339; 428/473.5; 428/704; 428/702

(57) ABSTRACT

A UV curable intermediate transfer media, such as a belt, that includes a first supporting substrate layer, such as a polyimide substrate layer, and a second surface layer of an epoxy acrylate, a conductive compound, and a photoinitiator.

### CROSS REFERENCE TO RELATED APPLICATIONS

U.S. application Ser. No. (not yet assigned—Attorney Docket No. 20090442-US-NP) filed concurrently herewith, entitled Polymeric Intermediate Transfer Members, illustrates an intermediate transfer member comprised of a copolymer of a polyester, a polycarbonate, and a polyalkylene glycol.

U.S. application Ser. No. (not yet assigned—Attorney Docket No. 20090845-US-NP) filed concurrently herewith, entitled Silane Containing Intermediate Transfer Members, illustrates an intermediate transfer member comprised of a supporting substrate, a silane first intermediate layer, and contained on the silane layer a second layer of a self crosslinking acrylic resin; a mixture of a glycoluril resin and an acrylic polyol resin; or a mixture of a glycoluril resin and a self crosslinking acrylic resin.

U.S. application Ser. No. (not yet assigned—Attorney Docket No. 20090588-US-NP) filed concurrently herewith, illustrates an intermediate transfer member comprised of a phosphate ester, and a polymeric binder.

Copending U.S. application Ser. No. 12/550,594 (Attorney Docket No. 20090530-US-NP) filed Aug. 31, 2009, entitled Carbon Nanotube Containing Intermediate Transfer Members, discloses an intermediate transfer member comprised of a supporting substrate, and a carbon nanotube layer and which member optionally further includes in the carbon nanotube layer at least one of an epoxy acrylate, a photoinitiator, an optional acrylate monomer, and an optional vinyl monomer.

Copending U.S. application Ser. No. 12/413,645 (Attorney Docket No. 20081432-US-NP), filed Mar. 30, 2009, entitled Layered Intermediate Transfer Members, illustrates an intermediate transfer member comprised of a polyimide substrate, and thereover a polyetherimide/polysiloxane.

Illustrated in U.S. application Ser. No. 12/200,074 (Attorney Docket No. 20080579-US-NP) entitled Hydrophobic Carbon Black Intermediate Transfer Components, filed Aug. 28, 2008, is an intermediate transfer member comprised of a substrate comprising a carbon black surface treated with a poly(fluoroalkyl acrylate).

Illustrated in U.S. application Ser. No. 12/129,995, filed May 30, 2008, the disclosure of which is totally incorporated herein by reference, entitled Polyimide Intermediate Transfer Components, is an intermediate transfer belt comprised of a substrate comprising a polyimide and a conductive component wherein the polyimide is cured at a temperature of, for example, from about 175 to about 290° C. over a period of time of from about 10 to about 120 minutes.

### BACKGROUND

Disclosed are intermediate transfer members, and more specifically, intermediate transfer members selected for transferring images, such as a developed image in an electrostatographic, for example xerographic, including digital, image on image, and the like, machines or apparatuses and printers. In embodiments, there are selected intermediate transfer members comprised of a supporting substrate, such as a polyimide first layer, and a UV (ultraviolet light) curable or UV cured second layer comprised of a mixture of a conductive component like a conductive carbon black, a metal oxide, a polyaniline, and the like; an epoxy acrylate, a photoinitiator like an acyl phosphine photoinitiator, and as optional components acrylates in addition to epoxy acrylates, and vinyl polymers.

A number of advantages are associated with the intermediate transfer members of the present disclosure in embodiments thereof, such as excellent mechanical characteristics, robustness, consistent, and excellent surface resistivities, excellent image transfer (toner transfer and cleaning), as compared to a number of known intermediate transfer members with a polyimide base layer; acceptable adhesion properties, when there is included in the plural layered intermediate transfer member an adhesive layer; excellent maintained conductivity or resistivity for extended time periods; dimensional stability; where member is an ITB (intermediate transfer belt) with humidity insensitivity for extended time periods; excellent dispersability in a polymeric solution; low and acceptable surface friction characteristics; and minimum or substantially no peeling or separation of the layers.

More specifically, as UV curing technology matures, it offers a number of advantages that are achievable in embodiments thereof with the disclosed intermediate transfer members, such advantages being, for example, environmental acceptance, for example, there is almost zero volatiles of organic solvents; desirable physical properties like exceptional stain, abrasion and solvent resistance characteristics together with excellent toughness such as extended wear resistant properties; high gloss, such as greater than about 30 gloss units in embodiments, characteristics and preparation and production efficiencies, that is the ITB is cured rapidly and within seconds.

Accordingly, in embodiments of the present disclosure, the intermediate transfer members allow UV light to penetrate across the surface layer for a complete, almost 100 percent cure.

In aspects thereof, the present disclosure relates to a multilayer intermediate transfer member, such as a belt (ITB) comprised of a polyimide base layer, where the polyimide layer further includes as an optional additive a conductive component, an optional adhesive layer in contact with the polyimide layer and a top or surface layer comprised of the mixture of components illustrated herein, and which layered member can be prepared by known solution casting methods and known extrusion molded processes with the optional adhesive layer being applied by known spray coating and flow coating processes.

In a typical electrostatographic reproducing apparatus, such as xerographic copiers, printers, multifunctional systems, a light image of an original to be reproduced is recorded in the form of an electrostatic latent image upon a photosensitive member or a photoconductor, and the latent image is subsequently rendered visible by the application of a toner comprised of thermoplastic resin particles and colorant. Generally, the electrostatic latent image is developed by contacting it with a dry toner mixture, having toner particles adhering triboelectrically to carrier particles, or a liquid developer material, which may include a liquid carrier having toner particles dispersed therein. The developer material is advanced into contact with the formed electrostatic latent image present on the photoconductor, and the toner particles are deposited thereon in image configuration. Subsequently, the developed image can be transferred to a copy sheet, however, it can be advantageous to transfer the developed image to an intermediate transfer web, belt or component, and subsequently, transfer with a high transfer efficiency the developed image from the intermediate transfer member to a permanent substrate. The toner image is subsequently usually fixed or fused upon the substrate, which may be the photoconductor member itself, or a support sheet such as plain paper.

Intermediate transfer members possess a number of advantages, such as enabling high throughput at modest process speeds; improving registration of the final color toner image in color systems using synchronous development of one or more component colors, while using one or more transfer stations; and increasing the number of substrate components that can be selected. However, a disadvantage of using an intermediate transfer member is that a plurality of transfer operations is usually selected allowing for the possibility of charge exchange occurring between toner particles and the transfer member, which ultimately can lead to less than complete toner transfer, resulting in low resolution images on the image receiving substrate, and image deterioration. When the image is in color, the image can additionally suffer from color shifting and color deterioration.

Attempts at controlling the resistivity of intermediate transfer members by, for example, adding conductive fillers, such as ionic additives and/or carbon black to the outer layer, are disclosed in U.S. Pat. No. 6,397,034 which describes the use of fluorinated carbon filler in a polyimide intermediate transfer member layer. However, there can be problems associated with the use of such fillers in that undissolved particles frequently bloom or migrate to the surface of the fluorinated polymer and cause imperfections to the polymer, thereby causing nonuniform resistivity, which in turn causes poor antistatic properties and poor mechanical strength characteristics. Also, ionic additives on the ITB surface may interfere with toner release. Furthermore, bubbles may appear in the polymer, some of which can only be seen with the aid of a microscope, and others of which are large enough to be observed with the naked eye resulting in poor or nonuniform electrical properties, and poor mechanical properties.

In addition, the ionic additives themselves are sensitive to changes in temperature, humidity, and operating time. These sensitivities often limit the resistivity range. For example, the resistivity usually decreases by up to two orders of magnitude or more as the humidity increases from about 20 to 80 percent relative humidity. This effect limits the operational or process latitude.

Moreover, ion transfer, it is believed, can also occur in the systems of the U.S. Pat. No. 6,397,034. The transfer of ions leads to charge exchanges and insufficient transfers, which in turn causes low image resolution and image deterioration, thereby adversely affecting the copy quality. In color systems, additional adverse results include color shifting and color deterioration. Ion transfer also increases the resistivity of the polymer member after repetitive use. This can limit the process and operational latitude, and eventually the ion filled polymer member will be unusable.

Therefore, it is desired to provide an intermediate transfer member with a number of the advantages illustrated herein, such as excellent mechanical, and humidity insensitivity characteristics, and permitting high copy quality where developed images with minimal resolution issues can be obtained. It is also desired to provide a weldable intermediate transfer belt that may not, but could have puzzle cut seams, and instead has a weldable seam, thereby providing a belt that can be manufactured without labor intensive steps, such as manually piecing together the puzzle cut seam with fingers, and without the lengthy high temperature and high humidity conditioning steps.

### REFERENCES

Illustrated in U.S. Pat. No. 7,031,647 is an imageable seamed belt containing a lignin sulfonic acid doped polyaniline.

Illustrated in U.S. Pat. No. 7,139,519 is an intermediate transfer belt, comprising a belt substrate comprising primarily at least one polyimide polymer; and a welded seam.

Illustrated in U.S. Pat. No. 7,130,569 is a weldable intermediate transfer belt comprising a substrate comprising a homogeneous composition comprising a polyaniline in an amount of, for example, from about 2 to about 25 percent by weight of total solids, and a thermoplastic polyimide present in an amount of from about 75 to about 98 percent by weight of total solids, wherein the polyaniline has a particle size of, for example, from about 0.5 to about 5 microns.

Puzzle cut seam members are disclosed in U.S. Pat. Nos. 5,487,707; 6,318,223, and 6,440,515.

Illustrated in U.S. Pat. No. 6,602,156 is a polyaniline filled polyimide puzzle cut seamed belt, however, the manufacture of a puzzle cut seamed belt is labor intensive and costly, and the puzzle cut seam, in embodiments, is sometimes weak. The manufacturing process for a puzzle cut seamed belt usually involves a lengthy in time high temperature and high humidity conditioning step. For the conditioning step, each individual belt is rough cut, rolled up, and placed in a conditioning chamber that is environmentally controlled at about 45° C. and about 85 percent relative humidity, for approximately 20 hours. To prevent or minimize condensation and watermarks, the puzzle cut seamed transfer belt resulting is permitted to remain in the conditioning chamber for a suitable period of time, such as 3 hours. The conditioning of the transfer belt renders it difficult to automate the manufacturing thereof, and the absence of such conditioning may adversely impact the belt's electrical properties, which in turn results in poor image quality.

### EMBODIMENTS

In aspects thereof, there is disclosed an intermediate transfer member comprised of a supporting substrate, and a mixture of a conductive component, an epoxy acrylate, and a photoinitiator; an intermediate transfer member comprised of a polyimide supporting substrate layer, and thereover a layer comprised of a mixture of a conductive compound, an epoxy acrylate polymer, and a photoinitiator; an intermediate transfer member comprised of a polyimide supporting substrate layer, and thereover a layer comprised of a mixture of a conductive compound, an epoxy acrylate polymer, an optional acrylate monomer or other suitable monomer, and a photoinitiator, wherein the epoxy acrylate is one of an aliphatic epoxy acrylate, an aromatic epoxy acrylate, an acrylated epoxy linseed oil, or a fatty acid modified epoxy diacrylate, and mixtures thereof, each present in an amount of from about 20 to about 80 weight percent of the layer mixture components; the photoinitiator is selected from the group consisting of diphenyl (2,4,6-trimethylbenzoyl) phosphine oxide, diphenyl (2,4,6-trimethylbenzoyl) phosphinate, phenyl bis(2,4,6-trimethyl benzoyl) phosphine oxide, 1-hydroxy-cyclohexylphenyl ketone, 2-hydroxy-2-methyl-1-phenyl-1-propanone, 2-hydroxy-1-[4-(2-hydroxyethoxy) phenyl]-2-methyl-1-propanone, 2-benzyl-2-(dimethylamino)-1-[4-(4-morpholinyl) phenyl]-1-butanone, 2-methyl-1-[4-(methylthio)phenyl]-2-(4-morpholinyl)-1-propanone, and α,α-dimethoxy-α-phenylacetophenone, and mixtures thereof, each present in an amount of from about 1 to about 10 weight percent of the mixture layer; and the conductive compound is a carbon black, a polyaniline, or a metal oxide, and mixtures thereof, each present in an amount of from about 3 to about 50 weight percent of the layer; a transfer belt comprised of a supporting substrate, and thereover a coating comprised of a conductive component, an epoxy acrylate, and a photoinitiator, and which coating is in the form of a layer; an intermediate transfer member comprised of a supporting substrate, and a coating thereover comprised of a mixture of a conductive component like a conductive carbon black, a metal oxide, a polyaniline, mixtures thereof, and the like, and an epoxy acrylate, a photoinitiator like an acyl phosphine photoinitiator, and as optional components acrylates in addition to epoxy acrylates, and vinyl polymers; an intermediate transfer member comprised of a polyimide supporting substrate layer, and thereover a layer comprised of the mixture illustrated herein, inclusive of a photoinitiator and a suitable monomer, and where this layer is UV curable; an intermediate transfer member comprised of a polyimide supporting substrate layer, a coating surface layer thereover comprised of the mixture of components illustrated herein, and wherein the mixture includes a conductive component like a conductive carbon black, a metal oxide, a polyaniline, and the like; an intermediate transfer member comprised of an epoxy acrylate, an acyl phosphine photoinitator, and acrylates in addition to epoxy acrylates, and vinyl polymers; and where the photoinitiator is represented by

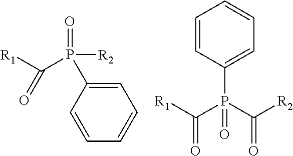

wherein R₁ and R₂ are independently alkyl, aryl, or mixtures thereof; a transfer media comprised of a polyimide first supporting substrate layer, and thereover a second layer comprised of a conductive component like a conductive carbon black, a metal oxide or a polyaniline, an epoxy acrylate, and an acyl phosphine photoinitator, as illustrated herein, an adhesive layer situated between the first layer and the second layer, and wherein the first layer further contains a known conductive component like a carbon black, a polyaniline, a metal oxide, and the like; an intermediate transfer belt comprised of a polyimide substrate layer, and thereover a layer comprised of a mixture of a conductive carbon black, a metal oxide like antimony tin oxide, a polyaniline, and the like, an epoxy acrylate, an acyl phosphine photoinitator, and as optional components acrylate monomers in addition to epoxy acrylates, and vinyl polymers, and wherein the substrate layer further includes a conductive component; wherein the substrate is of a thickness of from about 20 to about 500 microns, and the mixture layer is of a thickness of from about 1 to about 150 microns; an intermediate transfer member comprising, for example, a polyimide supporting substrate that contains a suitable carbon black, a suitable polyaniline, or a suitable metal oxide, and thereover a cured mixture coating as illustrated herein, and which mixture further includes a polymer selected from the group consisting of a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, and mixtures thereof, each present in an amount of from about 1 to about 80 weight percent of the total surface layer.

Examples of supporting substrates include polyimides, polyamideimides, polyetherimides, and mixtures thereof.

Specific examples of supporting substrates are polyimides inclusive of known low temperature and rapidly cured polyimide polymers, such as VTEC™ PI 1388, 080-051, 851, 302, 203, 201, and PETI-5, all available from Richard Blaine International, Incorporated, Reading, Pa. These thermosetting polyimides can be cured at temperatures of, for example, from about 180° C. to about 260° C. over a short period of time, such as from about 10 to about 120 minutes, or from about 20 to about 60 minutes; possess a number average molecular weight of from about 5,000 to about 500,000, or from about 10,000 to about 100,000, and a weight average molecular weight of from about 50,000 to about 5,000,000, or from about 100,000 to about 1,000,000 where the molecular weights can be determined by GPC analysis or other know similar methods. Also, for the supporting substrate there can be selected thermosetting polyimides that can be cured at temperatures of above 300° C., such as PYRE M.L® RC-5019, RC 5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Suitable supporting substrate polyimides include those formed from various diamines and dianhydrides, such as polyimide, polyamideimide, polyetherimide, and the like. More specifically, polyimides include aromatic polyimides such as those formed by reacting pyromellitic acid and diaminodiphenylether, or by imidization of copolymeric acids, such as biphenyltetracarboxylic acid and pyromellitic acid with two aromatic diamines, such as p-phenylenediamine and diaminodiphenylether. Another suitable polyimide includes pyromellitic dianhydride and benzophenone tetracarboxylic dianhydride copolymeric acids reacted with 2,2-bis[4-(8-aminophenoxy)phenoxy]-hexafluoropropane. Aromatic polyimides include those containing 1,2,1′,2′-biphenyltetracarboximide and para-phenylene groups, and those having biphenyltetracarboximide functionality with diphenylether end spacer characterizations. Mixtures of polyimides can also be used.

In embodiments, the polyamideimides selected as the supporting substrates can be synthesized by at least the following two methods (1) isocyanate method which involves the reaction between isocyanate and trimellitic anhydride; or (2) acid chloride method where there is reacted a diamine and trimellitic anhydride chloride. Examples of polyamideimides selected include VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15, T_{g}=255° C., and M_{w}=8,000), HR-13NX (30 weight percent solution in N-methylpyrrolidone/xylene=67/33, T_{g}=280° C., and M_{w}=10,000), HR-15ET (25 weight percent solution in ethanol/toluene=50/50, T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON® AI-10 (T_{g}=272° C.), commercially available from Solvay Advanced Polymers, LLC, Alpharetta, Ga.

The conductive material, such as a carbon black, a metal oxide or a polyaniline, is present in the substrate layer of the intermediate transfer member in, for example, an amount of from about 1 to about 60 weight percent, from about 3 to about 40 weight percent, and more specifically, from about 5 to about 15 weight percent.

More specifically, the carbon black selected surface groups can be formed by oxidation with an acid or with ozone, and where there is absorbed or chemisorbed oxygen groups from, for example, carboxylates, phenols, and the like. The carbon surface is essentially inert to most organic reaction chemistry except primarily for oxidative processes and free radical reactions.

The conductivity of carbon black is dependent on surface area and its structure primarily. Generally, the higher the surface area and the higher the structure, the more conductive is the carbon black. Surface area is measured by the B.E.T. nitrogen surface area per unit weight of carbon black, and is the measurement of the primary particle size. Structure is a complex property that refers to the morphology of the primary aggregates of carbon black. It is a measure of both the number of primary particles comprising primary aggregates, and the manner in which they are “fused” together. High structure carbon blacks are characterized by aggregates comprised of many primary particles with considerable “branching” and “chaining”, while low structure carbon blacks are characterized by compact aggregates comprised of fewer primary particles. Structure is measured by dibutyl phthalate (DBP) absorption by the voids within carbon blacks. The higher the structure, the more the voids, and the higher the DBP absorption.

Examples of carbon blacks selected as the conductive component for the ITM (intermediate transfer member) supporting substrate, and for the UV cured coating mixture layer thereover include VULCAN® carbon blacks, REGAL® carbon blacks, MONARCH® carbon blacks, and BLACK PEARLS® carbon blacks available from Cabot Corporation. Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); Channel carbon blacks available from Evonik-Degussa; Special Black 4 (B.E.T. surface area=180 m²/g, DBP absorption=1.8 ml/g, primary particle diameter=25 nanometers), Special Black 5 (B.E.T. surface area=240 m²/g, DBP absorption=1.41 ml/g, primary particle diameter=20 nanometers), Color Black FW1 (B.E.T. surface area=320 m²/g, DBP absorption=2.89 ml/g, primary particle diameter=13 nanometers), Color Black FW2 (B.E.T. surface area=460 m²/g, DBP absorption=4.82 ml/g, primary particle diameter=13 nanometers), and Color Black FW200 (B.E.T. surface area=460 m²/g, DBP absorption=4.6 ml/g, primary particle diameter=13 nanometers).

The carbon black may exist as or be formed into a uniform dispersion, which dispersion is then coated on glass plates using a draw bar coating method. The resulting individual films can be dried at high temperatures, such as from about 100° C. to about 400° C., for a suitable period of time, such as from about 20 to about 180 minutes, while remaining on the separate glass plates. After drying and cooling to room temperature, about 23° C. to about 25° C., the films on the glass plates can be immersed into water overnight, about 18 to 23 hours, and subsequently, the 50 to 150 micron thick films can be released from the glass to form, after or prior to adding the coating mixture illustrated herein, the intermediate transfer member.

Adhesive layer components usually situated between the supporting substrate and the top mixture in the form of a layer are, for example, a number of resins or polymers of epoxy, urethane, silicone, polyester, and the like. Generally, the adhesive layer is a solventless layer, that is, materials that are liquid at room temperature (about 25° C.), and are able to crosslink to an elastic or rigid film to adhere at least two materials together. Specific adhesive layer components include 100 percent solids adhesives including polyurethane adhesives obtained from Lord Corporation, Erie, Pa., such as TYCEL® 7924 (viscosity from about 1,400 to about 2,000 cps), TYCEL® 7975 (viscosity from about 1,200 to about 1,600 cps) and TYCEL® 7276. The viscosity range of the adhesives is, for example, from about 1,200 to about 2,000 cps. The solventless adhesives can be activated with either heat, room temperature curing, moisture curing, ultraviolet radiation, infrared radiation, electron beam curing, or any other known technique. The thickness of the adhesive layer is usually less than about 100 nanometers, and more specifically, as illustrated hereinafter.

The thickness of each layer of the intermediate transfer member can vary, and is usually not limited to any specific value. In specific embodiments, the substrate layer or first layer thickness is, for example, from about 20 to about 300 microns, from about 30 to about 200 microns, from about 75 to about 150 microns, and from about 50 to about 100 microns, while the thickness of the top mixture layer is, for example, from about 1 to about 150 microns, from about 10 to about 100 microns, from about 20 to about 70 microns, and from about 30 to about 50 microns. The adhesive layer thickness is, for example, from about 1 to about 100 nanometers, from about 5 to about 75 nanometers, or from about 50 to about 100 nanometers.

Examples of epoxy acrylates selected for the coating mixture are aliphatic epoxy acrylates such as LAROMER® LR8765 (functionality of about 2 and molar mass of about 330 g/mol); aromatic epoxy acrylates such as LAROMER® LR8986 (functionality of about 2.4 and molar mass of about 510 g/mol), LR9019 (functionality of about 2.4 and molar mass of about 580 g/mol), LR9023 (functionality of about 2.4 and molar mass of about 480 g/mol), all available from BASF. Examples of epoxy acrylates that possess a suitable surface energy, and that can be selected for the mixture layer are available from Cognis Inc. as PHOTOMER® 3082 (acrylated epoxy linseed oil), and 3072 (fatty acid modified epoxy diacrylate), available from Cognis Inc.

The epoxy acrylates, which primarily provide for the coating mixture layer integrity, and are UV curable, are present in an amount of, for example, from about 5 to about 80 weight percent, or from about 10 to about 40 weight percent of the UV cured mixture layer components.

The mixture layer, in embodiments, can have added thereto acrylate monomers or vinyl monomers such as LAROMER® TMPTA (trimethylolpropane triacrylate), BDDA (butandiol diacrylate), HDDA (hexandiol diacrylate), TPGDA (tripropyleneglycol diacrylate), DPGDA (dipropyleneglycol diacrylate), POEA (phenoxyethyl acrylate), LR8887 (trimethylolpropaneformal monoacrylate), TBCH (4-t-butylcyclohexyl acrylate), LA (lauryl acrylate 12/14), EDGA (ethyldiglycol acrylate), BDMA (butandiol monoacrylate), DCPA (dihydrodicyclopentadienyl acrylate), DVE-3 (triethyleneglycol divinyl ether), vinyl caprolactam, n-vinyl formamide, all available from BASF; and CN4000 (fluorinated acrylate oligomer), available from Sartomer Co., Warrington, Pa.

The acrylate monomers or vinyl monomers function, for example, as diluents to reduce the viscosity of the coating dispersion, and as solvents for the photoinitiators, and crosslink with the epoxy acrylates by UV radiation to further provide for the coating mixture layer integrity and strength, and which monomers are present in an amount of from about 10 to about 80 weight percent, or from about 30 to about 60 weight percent of the components present in the coating mixture layer.

Examples of the photoinitiators selected for the mixture layer include, but are not limited to, acyl phosphines, α-hydroxyketones, benzyl ketals, α-aminoketones, and mixtures thereof; and which photoinitiators are selected in various suitable amounts, such as illustrated herein, and, for example, from about 0.1 to about 20 weight percent, from about 1 to about 10 weight percent, from about 3 to about 7 weight percent, and from 1 to about 5 weight percent.

Examples of acyl phosphine photoinitiators include mono acyl phosphine oxide (MAPO) such as DAROCUR® TPO; and bis acyl phosphine oxide (BAPO) such as IRGACURE® 819, both available from Ciba Specialty Chemicals. Specific examples of the acyl phosphine photoinitiators are diphenyl (2,4,6-trimethylbenzoyl) phosphine oxide (DAROCUR® TPO), diphenyl (2,4,6-trimethylbenzoyl) phosphine oxide (ESACURE® TPO, LAMBERTI Chemical Specialties, Gallarate, Italy), diphenyl (2,4,6-trimethylbenzoyl) phosphine oxide (FIRSTCURE® HMPP available from Albemarle Corporation, Baton Rouge, La.), diphenyl (2,4,6-trimethylbenzoyl) phosphine oxide (LUCIRIN® TPO, available from BASF, Ludwigshafen, Germany), diphenyl (2,4,6-trimethylbenzoyl) phosphinate (LUCIRIN® TPO-L), and phenyl bis(2,4,6-trimethyl benzoyl) phosphine oxide (IRGACURE® 819, available from Ciba Specialty Chemicals) where mono acycl acyl phosphine oxide (MAPO) and the acyl phosphine oxide (BAPO) being encompassed by the formulas/structures illustrated herein.

Examples of α-hydroxyketone photoinitiators selected for the mixture layer include 1-hydroxy-cyclohexylphenyl ketone (IRGACURE® 184), 2-hydroxy-2-methyl-1-phenyl-1-propanone (DAROCUR® 1173), and 2-hydroxy-1-[4-(2-hydroxyethoxy)phenyl]-2-methyl-1-propanone (IRGACURE® 2959), all available from Ciba Specialty Chemicals.

Examples of α-aminoketone photoinitiators selected for the mixture surface layer include 2-benzyl-2-(dimethylamino)-1-[4-(4-morpholinyl)phenyl]-1-butanone (IRGACURE® 369), and 2-methyl-1-[4-(methylthio)phenyl]-2-(4-morpholinyl)-1-propanone (IRGACURE® 907), both available from Ciba Specialty Chemicals.

Examples of benzyl ketal photoinitiators selected for the mixture top surface layer include α,α-dimethoxy-α-phenylacetophenone (IRGACURE® 651), available from Ciba Specialty Chemicals.

The photoinitiators act primarily as catalysts to initiate the polymerization upon UV radiation, and which photoinitiators are present, for example, in an amount of from about 0.5 to about 10 weight percent, or from about 3 to about 6 weight percent of the UV cured surface layer components.

The disclosed intermediate transfer belt substrate layers are, for example, seamless or, in embodiments, weldable, that is the seam of the member like a belt is weldable, and more specifically, may be ultrasonically welded to produce a seam. The surface resistivity of the disclosed intermediate transfer member is, for example, from about 10⁸ to about 10¹³ ohm/sq, or from about 10⁹ to about 10¹² ohm/sq. The sheet resistivity of the intermediate transfer weldable member is, for example, from about 10⁸ to about 10¹³ ohm/sq, or from about 10⁹ to about 10¹² ohm/sq.

The intermediate transfer members illustrated herein like intermediate transfer belts can be selected for a number of printing, and reproduction systems, inclusive of xerographic printing. For example, the disclosed intermediate transfer members can be incorporated into a multi-imaging system where each image being transferred is formed on the imaging or photoconductive drum at an image forming station, wherein each of these images is then developed at a developing station, and then transferred to the intermediate transfer member. The images may be formed on the photoconductor and developed sequentially, and then transferred to the intermediate transfer member. In an alternative method, each image may be formed on the photoconductor or photoreceptor drum, developed, and transferred in registration to the intermediate transfer member. In an embodiment, the multi-image system is a color copying system, wherein each color of an image being copied is formed on the photoreceptor drum, developed, and transferred to the intermediate transfer member.

Subsequent to the toner latent image being transferred from the photoreceptor drum to the intermediate transfer member, the intermediate transfer member may be contacted under heat and pressure with an image receiving substrate such as paper. The toner image on the intermediate transfer member is then transferred and fixed, in image configuration, to the substrate such as paper.

The intermediate transfer member present in the imaging systems illustrated herein, and other known imaging and printing systems, may be in the configuration of a sheet, a web, a belt, including an endless belt, or an endless seamed flexible belt; a roller, a film, a foil, a strip, a coil, a cylinder, a drum, an endless strip, and a circular disc. The intermediate transfer member can be comprised of a single layer, or it can be comprised of several layers, such as from about 2 to about 5 layers. In embodiments, the intermediate transfer member further includes an outer release layer.

Optional release layer examples situated on and in contact with the mixture layer, and of a suitable thickness of, for example, from about 0.5 to about 20 microns, from about 1 to about 10 microns, from about 1 to about 5 microns, and from about 0.01 to about 10 microns, include suitable materials, such as TEFLON®-like materials including fluorinated ethylene propylene copolymer (FEP), polytetrafluoroethylene (PTFE), polyfluoroalkoxy polytetrafluoroethylene (PFA TEFLON®) and other TEFLON®-like materials; silicone materials such as fluorosilicones and silicone rubbers, such as Silicone Rubber 552, available from Sampson Coatings, Richmond, Va., (polydimethyl siloxane/dibutyl tin diacetate, 0.45 gram DBTDA per 100 grams polydimethyl siloxane rubber mixture with, for example, a molecular weight M_{w} of approximately 3,500); and fluoroelastomers such as those available as VITON® such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, VITON E45®, and VITON GF®. The VITON® designation is a Trademark of E.I. DuPont de Nemours, Inc. Two known fluoroelastomers are comprised of (1) a class of copolymers of vinylidenefluoride, and hexafluoropropylene, known commercially as VITON A®; (2) a class of terpolymers of vinylidenefluoride, hexafluoropropylene, and tetrafluoroethylene, known commercially as VITON B®, and (3) a class of tetrapolymers of vinylidenefluoride, hexafluoropropylene, tetrafluoroethylene, and a cure site monomer, such as VITON GF®, having 35 mole percent of vinylidenefluoride, 34 mole percent of hexafluoropropylene, and 29 mole percent of tetrafluoroethylene with 2 percent cure site monomer. The cure site monomer can be those available from E.I. DuPont de Nemours, Inc., such as 4-bromoperfluoro butene-1,1,1-dihydro-4-bromoperfluorobutene-1,3-bromoperfluoropropene-1,1,1-dihydro-3-bromoperfluoropropene-1, or any other suitable known commercially available cure site monomer.

The intermediate transfer layer or layers may be deposited on the substrate by known coating processes. Known methods for forming coating mixture on the substrate include dipping, spraying, such as by multiple spray applications of thin films, casting, flow coating, web coating, roll coating, extrusion, molding, or the like. In embodiments, the layer or layers can be deposited or generated by spraying such as by multiple spray applications of thin films, casting, by web coating, by flow coating, and more specifically, by lamination.

The circumference of the intermediate transfer member, especially as it is applicable to a film or a belt configuration, is, for example, from about 250 to about 2,500 millimeters, from about 1,500 to about 3,000 millimeters, or from about 2,000 to about 2,200 millimeters with a corresponding width of, for example, from about 100 to about 1,000 millimeters, from about 200 to about 500 millimeters, or from about 300 to about 400 millimeters.

Specific embodiments will now be described in detail. These examples are intended to be illustrative, and are not limited to the materials, conditions, or process parameters set forth in these embodiments. All parts are percentages by weight of total solids unless otherwise indicated.

### COMPARATIVE EXAMPLE 1

### Preparation of a Single Polyimide Transfer Member

One gram of Color Black FW1 (B.E.T. surface area of 320 m²/g, DBP absorption of 2.89 ml/g, primary particle diameter of 13 nanometers) as obtained from Evonik-Degussa, was mixed with 26.25 grams of a polyamic acid (polyimide precursor) solution, VTEC™ PI 1388 (20 weight percent solution in N-methylpyrrolidone, T_{g}>320° C.), as obtained from Richard Blaine International, Incorporated. By ball milling this mixture with 2 millimeter stainless shot with an Attritor for 1 hour, a uniform dispersion was obtained. The resulting dispersion was then coated on a glass plate using a draw bar coating method. Subsequently, the film obtained was dried at 100° C. for 20 minutes, and then at 200° C. for an additional 60 minutes while remaining on the glass plate.

The single layer film on the glass obtained above was then immersed into water overnight, about 23 hours, and the freestanding film was released from the glass automatically resulting in a single layer intermediate transfer member with a 75 micron thick carbon black/polyimide layer with a ratio by weight percent of 14 carbon black and 86 polyimide.

### EXAMPLE I

### Preparation of a Coated Mixture Transfer Member

A polyimide base layer was prepared as follows. One gram of Color Black FW1 (B.E.T. surface area of 320 m²/g, DBP absorption of 2.89 ml/g, primary particle diameter of 13 nanometers), as obtained from Evonik-Degussa, was mixed with 26.25 grams of a polyamic acid (polyimide precursor) solution, VTEC™ PI 1388 (20 weight percent solution in N-methylpyrrolidone, T_{g}>320° C.), as obtained from Richard Blaine International, Incorporated. By ball milling this mixture with 2 millimeter stainless shot with an Attritor for 1 hour, a uniform dispersion was obtained. The resulting dispersion was then coated on a glass plate using a draw bar coating method. Subsequently, the film obtained was dried at 100° C. for 20 minutes, and then at 200° C. for an additional 60 minutes while remaining on the glass plate.

A top coating mixture subsequently deposited on the above polyimide layer, which was prepared by milling and cured with UV, was generated as follows. 8.7 Grams of antimony tin oxide as a conductive component was mixed with 17.4 grams of the epoxy acrylate, LAROMER® LR8765 (functionality of about 2 and molar mass of about 330 g/mol, obtained from BASF), 69.6 grams of the acrylate monomer, LAROMER® DPGDA (dipropyleneglycol diacrylate, available from BASF), and 4.3 grams of the photoinitiator, IRGACURE® 819 (phenyl bis(2,4,6-trimethyl benzoyl) phosphine oxide, obtained from Ciba Specialty Chemicals). By ball milling this mixture in an Attritor with 2 millimeter stainless shot shots at 200 rpm for 2 hours, a uniform dispersion was obtained. After filtration through a 20 micron Nylon cloth, the dispersion obtained was then coated on the above polyimide/carbon black base layer using a known draw bar coating method. The dual layer obtained ITB was then cured under UV with a Hanovia UV instrument for a period of 10 seconds (325 nanometer UV, 125 watts) resulting in a 5 micron UV cured surface layer comprising antimony tin oxide/LAROMER® LR8765/LAROMER® DPGDA/IRGACURE® 819 with a ratio of 8.7/17.4/69.6/4.3 with a functional resistivity of 8.52×10¹¹ ohm/sq as measured by a High Resistivity Meter (Hiresta-Up MCP-HT450, available from Mitsubishi Chemical Corp.), and excellent mechanical properties, that was, a hardness of 3H as measured using the known pencil hardness test.

### EXAMPLE II

A 5 micron carbon black (color black FW-1 from Evonik) based UV cured surface layer (color black FW-1/LAROMER® LR8765/LAROMER® DPGDA/IRGACURE® 819=5/40/50/5) was prepared by repeating the above Example I process. With UV curing for 30 seconds, a functional ITB device was obtained with a surface resistivity of 6.52×10⁹ ohm/sq.

The disclosed Example I and Example II UV cured surface layers possess functional resistivity and excellent mechanical properties; the surface layers were cured in about 5 seconds without any volatile organic compounds being released. In contrast, the Comparative Example 1 carbon black polyimide layer consumed several hours of curing time with this thermal curing releasing organic solvents into the environment.

Furthermore, the disclosed Example II UV cured surface layer can be readily rendered to possess a low surface energy by the incorporation into this layer of a fluoroacrylate where the fluoro component crosslinks with other components in the mixture to form a crosslinked layer. It is believed that a low surface energy surface layer would aid in toner transfer and cleaning, thus extending the ITB life.

### EXAMPLE III

### Preparation of a Coated Mixture Transfer Member of Low Surface Energy

A polyimide substrate layer is prepared by repeating the process of Example I. The UV curable coating mixture is prepared as follows. 8.7 Grams of antimony tin oxide, as a conductive component, are mixed with 17.4 grams of the epoxy acrylate, LAROMER® LR8765 (functionality of about 2 and molar mass of about 330 g/mol, available from BASF), 67.6 grams of the acrylate monomer, LAROMER® DPGDA (dipropyleneglycol diacrylate, available from BASF), 2 grams of the fluoroacrylate, CN4000, available from Sartomer Company, and 4.3 grams of the photoinitiator, IRGACURE® 819 (phenyl bis(2,4,6-trimethyl benzoyl) phosphine oxide, obtained from Ciba Specialty Chemicals). By ball milling this mixture in an Attritor with 2 millimeter stainless shot shots at 200 rpm for 2 hours, a uniform dispersion is obtained. After filtration through a 20 micron Nylon cloth, the dispersion obtained is then coated on the above polyimide/carbon black base layer using a known draw bar coating method. The dual layer obtained ITB is then cured under UV with a Hanovia UV instrument for a period of 20 seconds (325 nanometer UV, 125 watts) resulting in, it is believed, a 5 micron UV cured surface layer comprising antimony tin oxide/LAROMER® LR8765/Laromer® DPGDA/CN4000/IRGACURE® 819 with a ratio of 8.7/17.4/67.6/2/4.3.

It is believed that the Example III ITB should possess a higher contact angle than the Comparative Example 1 ITB, which higher angle is believed to assist in toner transfer and toner cleaning.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. An intermediate transfer member comprised of a supporting substrate, and a mixture comprised of a conductive component, an epoxy acrylate, and a photoinitiator.

2. An intermediate transfer member in accordance with claim 1 wherein said supporting substrate is a polyimide, and said mixture is in contact with said polyimide as a surface layer thereof, and which surface layer is cured by ultraviolet light.

3. An intermediate transfer member in accordance with claim 1 wherein said supporting substrate is a polyimide, and wherein said conductive component is one of a carbon black, a metal oxide, a polyaniline, and mixtures thereof, each present in an amount of from about 3 to about 60 weight percent of said mixture.

4. An intermediate transfer member in accordance with claim 1 wherein said epoxy acrylate is one of an aliphatic epoxy acrylate, an aromatic epoxy acrylate, an acrylated epoxy linseed oil, or a fatty acid modified epoxy diacrylate, and mixtures thereof, each present in an amount of from about 5 to about 80 weight percent of said mixture.

5. An intermediate transfer member in accordance with claim 1 wherein said epoxy acrylate possesses a molar mass of from about 200 to about 1,500, and is present in an amount of from about 10 to about 40 weight percent of said mixture.

6. An intermediate transfer member in accordance with claim 1 wherein said photoinitiator is one of an acyl phosphine, an α-hydroxyketone, a benzyl ketal, an α-aminoketone, each present in an amount of from about 0.5 to about 10 weight percent of said mixture, and mixtures thereof,

7. An intermediate transfer member in accordance with claim 1 further including in said mixture in the configuration of a layer a polymer selected from the group consisting of a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, each present in an amount of from about 1 to about 80 weight percent of the total mixture layer components, and mixtures thereof.

8. An intermediate transfer member in accordance with claim 1 further including in said mixture at least one of an acrylate monomer, an acrylate polymer, and a vinyl monomer.

9. An intermediate transfer member in accordance with claim 8 wherein said acrylate monomer is at least one of trimethylolpropane triacrylate, butanediol diacrylate, hexanediol diacrylate, tripropyleneglycol diacrylate, dipropyleneglycol diacrylate, phenoxyethyl acrylate, trimethylolpropaneformal monoacrylate, 4-t-butylcyclohexyl acrylate, lauryl acrylate, ethyldiglycol acrylate, butanediol monoacrylate, dihydrodicyclopentadienyl acrylate, or a fluorinated acrylate oligomer, and mixtures thereof; said acrylate polymer is at least one of a polyester acrylate, a urethane acrylate, a polyether acrylate, each present in an amount of from about 10 to about 80 weight percent of the total mixture components, and mixtures thereof, and said vinyl monomer is at least one of triethyleneglycol divinyl ether, vinyl caprolactam, n-vinyl formamide, and mixtures thereof.

10. An intermediate transfer member in accordance with claim 1 wherein said photoinitiator is selected from the group consisting of diphenyl (2,4,6-trimethylbenzoyl) phosphine oxide, diphenyl (2,4,6-trimethylbenzoyl) phosphinate, phenyl bis(2,4,6-trimethyl benzoyl) phosphine oxide, 1-hydroxy-cyclohexylphenyl ketone, 2-hydroxy-2-methyl-1-phenyl-1-propanone, 2-hydroxy-1-[4-(2-hydroxyethoxy) phenyl]-2-methyl-1-propanone, 2-benzyl-2-(dimethylamino)-1-[4-(4-morpholinyl) phenyl]-1-butanone, 2-methyl-1-[4-(methylthio)phenyl]-2-(4-morpholinyl)-1-propanone, and α,α-dimethoxy-α-phenylacetophenone, each present in an amount of from about 2 to about 7 weight percent of the total mixture components.

11. An intermediate transfer member in accordance with claim 10 further including in said mixture an acrylate monomer of at least one of trimethylolpropane triacrylate, butanediol diacrylate, hexanediol diacrylate, tripropyleneglycol diacrylate, dipropyleneglycol diacrylate, phenoxyethyl acrylate, trimethylolpropaneformal monoacrylate, 4-t-butylcyclohexyl acrylate, lauryl acrylate, ethyldiglycol acrylate, butanediol monoacrylate, dihydrodicyclopentadienyl acrylate, or fluorinated acrylate oligomer, and mixtures thereof; and optionally further including in said mixture a vinyl monomer of one of triethyleneglycol divinyl ether, vinyl caprolactam, n-vinyl formamide, each present in an amount of from about 10 to about 80 weight percent of the total mixture, in the form of a layer, components.

12. An intermediate transfer member in accordance with claim 11 wherein said acrylate monomer is trimethylolpropane triacrylate, butanediol diacrylate, hexanediol diacrylate, tripropyleneglycol diacrylate, or dipropyleneglycol diacrylate, each present in an amount of from about 30 to about 60 weight percent of the total mixture.

13. An intermediate transfer member in accordance with claim 1 with a surface resistivity of from about 10⁸ to about 10¹³ ohm/sq.

14. An intermediate transfer member in accordance with claim 1 further comprising an outer release layer positioned on said mixture, and which mixture is in the form of a layer.

15. An intermediate transfer member in accordance with claim 14 wherein said release layer comprises a fluorinated ethylene propylene copolymer, a polytetrafluoroethylene, a polyfluoroalkoxy polytetrafluoroethylene, a fluorosilicone, a polymer of vinylidenefluoride, hexafluoropropylene, tetrafluoroethylene, or mixtures thereof.

16. An intermediate transfer member in accordance with claim 1 further including in said supporting substrate a conductive component present in an amount of from about 1 to about 40 percent by weight of the total substrate.

17. An intermediate transfer member in accordance with claim 16 wherein said conductive component is a carbon black, a polyaniline, or a metal oxide, each present in an amount of from about 2 to about 25 percent by weight of the total substrate components.

18. An intermediate transfer member comprised of a polyimide supporting substrate layer, and thereover a layer comprised of a mixture of a conductive compound, an epoxy acrylate polymer, and a photoinitiator.

19. An intermediate transfer member in accordance with claim 18 wherein said photoinitiator is represented by 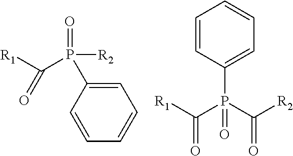
wherein R₁ and R₂ are alkyl, aryl, or mixtures thereof.

20. An intermediate transfer member in accordance with claim 18 wherein said conductive compound is present in an amount of from about 3 to about 40 weight percent; said epoxy acrylate polymer is present in an amount of from about 20 to about 60 weight percent; said photoinitiator is present in an amount of from about 1 to about 5 weight percent of the mixture layer components, and the total thereof is 100 percent.

21. An intermediate transfer member in accordance with claim 19 wherein R₁ and R₂ are alkyl containing from 1 to about 12 carbon atoms, or aryl containing from 6 to about 18 carbon atoms.

22. An intermediate transfer member in accordance with claim 1 further including an adhesive layer situated between the supporting substrate and the mixture in the form of a layer.

23. An intermediate transfer member in accordance with claim 22 wherein said adhesive layer is of a thickness of from about 1 to about 100 nanometers, and said layer is comprised of an epoxy, a urethane, a silicone, or a polyester.

24. An intermediate transfer member in accordance with claim 1 wherein said substrate is of a thickness of from about 20 to about 500 microns, said mixture is in the form of a layer and is of a thickness of from about 1 to about 150 microns.

25. An intermediate transfer member in accordance with claim 1 wherein said supporting substrate is a polyimide, a polyetherimide, or a polyamideimide.

26. An intermediate transfer member comprised of a polyimide supporting substrate layer, and thereover a layer comprised of a mixture of a conductive compound, an epoxy acrylate polymer, and a photoinitiator, wherein said epoxy acrylate is one of an aliphatic epoxy acrylate, an aromatic epoxy acrylate, an acrylated epoxy linseed oil, or a fatty acid modified epoxy diacrylate, each present in an amount of from about 20 to about 80 weight percent of said layer; said photoinitiator is selected from the group consisting of diphenyl (2,4,6-trimethylbenzoyl) phosphine oxide, diphenyl (2,4,6-trimethylbenzoyl) phosphinate, phenyl bis(2,4,6-trimethyl benzoyl) phosphine oxide, 1-hydroxy-cyclohexylphenyl ketone, 2-hydroxy-2-methyl-1-phenyl-1-propanone, 2-hydroxy-1-[4-(2-hydroxyethoxy) phenyl]-2-methyl-1-propanone, 2-benzyl-2-(dimethylamino)-1-[4-(4-morpholinyl) phenyl]-1-butanone, 2-methyl-1-[4-(methylthio)phenyl]-2-(4-morpholinyl)-1-propanone, or α,α-dimethoxy-α-phenylacetophenone, each present in an amount of from about 1 to about 10 weight percent of said layer; and said conductive compound is a carbon black, a polyaniline, or a metal oxide, each present in an amount of from about 3 to about 50 weight percent of said layer.

27. An intermediate transfer member in accordance with claim 26 wherein said epoxy acrylate is an aliphatic epoxy acrylate, and said metal oxide is an antimony tin oxide.

28. An intermediate transfer member in accordance with claim 26 wherein said epoxy acrylate is an aliphatic epoxy acrylate, or an aromatic epoxy acrylate, each present in an amount of from about 25 to about 50 weight percent of said mixture layer; said photoinitiator is phenyl bis(2,4,6-trimethyl benzoyl) phosphine oxide, present in an amount of from about 1 to about 10 weight percent of said mixture layer; and said conductive compound is present in an amount of from about 3 to about 20 weight percent of said mixture layer.

29. An intermediate transfer member in accordance with claim 26 wherein said layer mixture further includes an acrylate monomer.

30. An intermediate transfer member in accordance with claim 29 wherein said acrylate monomer is dipropylene glycol diacrylate; said photoinitiator is phenyl bis(2,4,6-trimethyl benzoyl) phosphine oxide, and said conductive component is an antimony tin oxide.
